(19) United States
(12) Patent Application Publication
(10) Pub. No.: US 2012/0025023 A1
(43) Pub. Date: Feb. 2, 2012

(54) LONGITUDINAL JUNCTION FOR AIRCRAFT FUSELAGE PANELS IN COMPOSITE MATERIALS

(75) Inventors: Patrick Bernard, Colomiers (FR); Sebastien Riva, Mondonville (FR)

(73) Assignee: AIRBUS OPERATIONS (inc. as a Soc. par Act. Simpl.), Toulouse (FR)

(21) Appl. No.: 13/143,495

(22) PCT Filed: Dec. 31, 2009
(86) PCT No.: PCT/FR2009/052726

§ 371 Date: Oct. 12, 2011

(30) Foreign Application Priority Data
Jan. 8, 2009 (FR) 0950087

(51) Int. Cl. B64C 1/06

(52) U.S. Cl. 244/131

(57) ABSTRACT

An aircraft fuselage structure including at least a first and a second panel made of composite materials, placed side by side along a juncture and assembled with one another through at least one longitudinal joint. The longitudinal joint includes a double Ω stringer including: a first and a second Ω element each including a head and two cores, a first side base-plate situated in continuity of the first core of the first Ω element, a second side base-plate situated in continuity of the last core of the second Ω element, and a central base-plate connecting the second core of the first Ω element with the first core of the second Ω element and covering the juncture between the two panels.

### FIELD OF THE INVENTION

The invention relates to a longitudinal assembly joint of two aircraft fuselage panels made of composite material. This longitudinal joint integrates omega stringers adapted in particular to structures made of composite materials.

The invention finds applications in the area of assembly of aircraft fuselage panels, and especially in the area of assembly of panels made of composite materials using omega stringers as stiffeners.

### STATE OF THE ART

An aircraft fuselage is a structure generally comprising several more or less cylindrical sections butt-jointed to each other along joint lines, called circumferential joints, defining planes perpendicular to the longitudinal axis of the fuselage.

Each section generally is made up of several panels assembled with each other along joint lines, or juncture lines, positioned more or less along the generatrices of the fuselage.

These two types of joints are zones of fragility of the fuselage which it is advisable to reinforce to withstand the great stresses to which the fuselage is subjected in flight.

The panels of a section are assembled along a juncture line by means of longitudinal joints. These longitudinal joints may be implemented according to different techniques depending, in particular, on the type of structure of the aircraft. For example, in a metal fuselage structure, where all the panels are made of metal, the longitudinal joints may be implemented end to end, by means of stringers installed along the juncture of the panels to be assembled.

The stringers are sectional parts used in a fuselage structure of the aircraft to stiffen the skin and certain specific zones such as the door and window frames. The stringers may have sections of different shapes, for example T, Z, L, etc.

An exemplary metal aircraft fuselage structure in which the longitudinal joint is implemented by means of a T stringer has been shown on FIG. 1. In this example, the structure comprises a panel 1 (integrating a window 3) and a panel 2, to be assembled with one another. Panel 2 is stiffened through a plurality of Z stringers, referenced 4. Panels 1 and 2 are connected through a T stringer.

An exemplary longitudinal joint, along a cross-sectional view, implemented by means of a T stringer has been shown on FIG. 2. In this example, panels 1 and 2 are each stiffened by Z stringers 4 and assembled with one another by a T stringer 5. This T stringer forms the longitudinal joint along juncture 6 of panels 1 and 2 to be assembled. The T stringer is fastened, as shown on FIG. 2, by its horizontal base-plate 51, onto each of panels 1 and 2. Core 52 of the T stringer allows securing of other elements of the structure.

On these Figures, and in particular on FIG. 1, it is seen that the interval between two Z or T stringers is even.

In a composite environment, that is to say in an aircraft with an at least partially composite fuselage, the stringers used generally are omega stringers (or Ω stringers) in preference to Z or L stringers. In fact, Ω stringers provide a better stability and a better ability to withstand internal pressure. An exemplary composite structure stiffened by Ω stringers referenced 8 has been shown on FIG. 3.

Because of its non-solid form however, the Ω stringer cannot be used as a longitudinal joint. In fact, the positioning of an Ω stringer on the juncture between the panels to be assembled would not allow a covering of the said juncture. Consequently, in order to implement an end-to-end longitudinal joint, in a composite structure, using a T stringer has been considered. An exemplary longitudinal joint with a T stringer is shown on FIG. 4. As explained above, T stringer 5 is fastened by its base-plate onto each of panels 1 and 2. Ω stringers 8 are fastened on both sides of juncture 6 to stiffen the structure. Nevertheless, the introduction of a T stringer 5 amid Ω stringers 8 has a significant impact on the stringer system, because the T stringers come to disrupt the distribution of the Ω stringers. The interval between stringers no longer is uniform and even, as shown on FIG. 3. In fact, because of their design, the intervals between two Ω stringers and two T stringers are different. Consequently, the introduction of a T stringer to form a longitudinal joint changes the interval between stringers, near the juncture of the two panels. The stringer system then cannot be optimized as a result of the presence of the T stringer.

Another technique has been considered for implementing a longitudinal joint in a composite structure stiffened by Ω stringers. This technique consists in using a U stringer 9 as a longitudinal joint, as shown on FIG. 5. Nevertheless, this U stringer also brings a disruption to the distribution of the stringer system because it does not make it possible to have a uniform and even stringer system between Ω stringers 8 and U stringer 9.

Another longitudinal joint technique is a technique by overlap of panels. This technique of joint by overlap of panels consists in placing the ends of the two panels to be assembled in overlap. For that, one of the panels is placed above the other, forming an over-thickness at the juncture. The overlap is implemented so that the outside panel is installed in the direction of the aerodynamic flow of the fuselage in order not to penalize the operating features of the aircraft.

An example of such a longitudinal joint by overlap is shown on FIG. 6. On this Figure, panels 1 and 2 are placed partially one over the other. In order to ensure assembly of the two panels at their juncture, one zone of one of the panels is deformed. In the example from FIG. 6, end 1a, 1b of panel 1 is deformed so as to be inserted beneath panel 2. Zone 1a of panel 1 is deformed so as to be placed beneath the end of panel 2. Zone 1b of panel 1 is deformed so as to ensure the continuity of the panel between zone 1a and non-deformed zone 1c.

In this example, panels 1 and 2 are stiffened by Ω stringers. Ω stringer 8 of panel 2 is fastened by fastening elements 7 through the two thicknesses of panels, that is to say through panel 2 and through zone 1a of panel 1.

Production of the deformed zone of the panel, however, is relatively costly. In fact, it requires a specific production mold for the panel made of composite material with a fold formation in order to produce the deformation. Furthermore, in the deformed zone, the Ω stringer is slanted, which precludes having a uniform and even stringer system within the set of Ω stringers. In fact, with such a technique, the Ω stringers are not all on the same circumferential plane as a result of the deformation of the end of one panel.

All the techniques cited above do not make it possible to obtain an optimum stringer system for the composite structure. In fact, the joint technique using a T stringer or a U stringer requires knowing beforehand the exact position of the joint stringer (T or U stringer) in order to be able to implement an Ω stringer system for the structure, degraded as little as possible (that is to say the most even possible). As to the joint technique by overlap of panels, it requires knowing the exact position of the joint in order to be able to produce the panel accordingly.

With such techniques, it is essential to know the position of the joint before producing the structure. It therefore is not possible to change the shape of a fuselage panel by using an already existing panel cut-out. Thus, in order to implement a different panel cut-out, requiring a new longitudinal joint 10, as shown on FIG. 7, it is necessary to completely change the stringer system of the panels situated around this longitudinal joint, any integration of a new longitudinal joint necessarily having impacts on the stringer system of the fuselage panels.

Explanation of the Invention

The invention has precisely as an object to remedy the disadvantages of the techniques explained above. For this purpose, the invention proposes a longitudinal joint, of edge-to-edge type, making it possible to assemble two fuselage panels made of composite material while maintaining an even interval between the stringers. This longitudinal joint is made up of a double Ω stringer comprising a central base-plate covering the juncture between the two panels. This longitudinal joint allows an edge-to-edge assembly of panels with a uniform and even omega stringer system.

More precisely, the invention relates to an aircraft fuselage structure comprising at least a first and a second panel made of composite material, placed side by side along a juncture and assembled with one another through at least one longitudinal joint, characterized in that the longitudinal joint consists of a double Ω stringer comprising:
a first and a second Ω element, each comprising a head and two cores,
a first side base-plate situated in the continuity of the first core of the first Ω element,
a second side base-plate situated in the continuity of the last core of the second Ω element, and
a central base-plate connecting the second core of the first Ω element with the first core of the second Ω element and covering the juncture between the two panels.

The invention may comprise one or more of the following characteristics:
the central base-plate has a length double that of the first or the second side base-plate.
the central base-plate is made in one piece with the Ω elements and the first and second side base-plates.
the central base-plate is fastened onto each panel by means of fastening elements placed on both sides of the juncture.
the longitudinal joint comprises a third stringer mounted on the central base-plate.
the third stringer is a T stringer.
the longitudinal joint comprises an inner or outer clamp mounted on the central base-plate.
the longitudinal joint comprises an over-thickness integrated into the central base-plate.

The invention also relates to an aircraft fuselage comprising at least two sections assembled by a circumferential joint, characterized in that each section comprises a structure such as described above.

The invention likewise relates to an aircraft, characterized in that it comprises at least one structure such as described above.

### BRIEF DESCRIPTION OF THE DRAWINGS

FIG. 1, already described, shows an exemplary metal fuselage structure with a longitudinal joint implemented with a T stringer.

FIG. 2, already described, shows a cross-sectional view of a longitudinal joint with a T stringer, on a metal structure.

FIG. 3, already described, shows an omega stringer system section of a structure made of composite material.

FIG. 4, already described, shows a cross-sectional view of a longitudinal joint with a T stringer, on a structure made of composite material.

FIG. 5, already described, shows a cross-sectional view of a longitudinal joint with a U stringer, on a structure made of composite material.

FIG. 6, already described, shows a cross-sectional view of a longitudinal joint by overlap of panels.

FIG. 7, already described, shows an exemplary aircraft section into which a new longitudinal joint is to be integrated.

FIG. 8 shows a cross-sectional view of a longitudinal joint according to the invention.

FIGS. 9, 10 and 11 show exemplary longitudinal joints according to the invention, with insertion of a T stringer, an additional clamp or an over-thickness of the stringer.

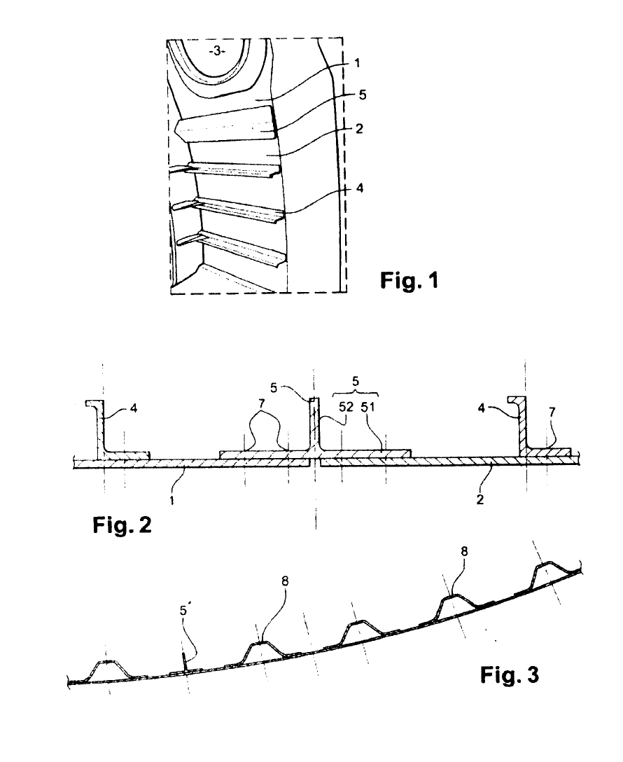

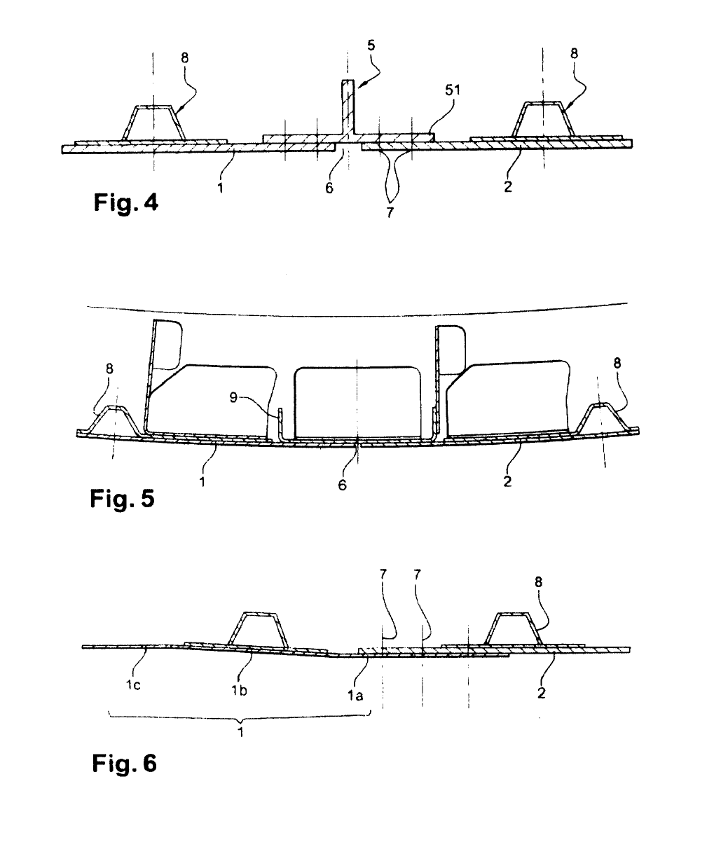

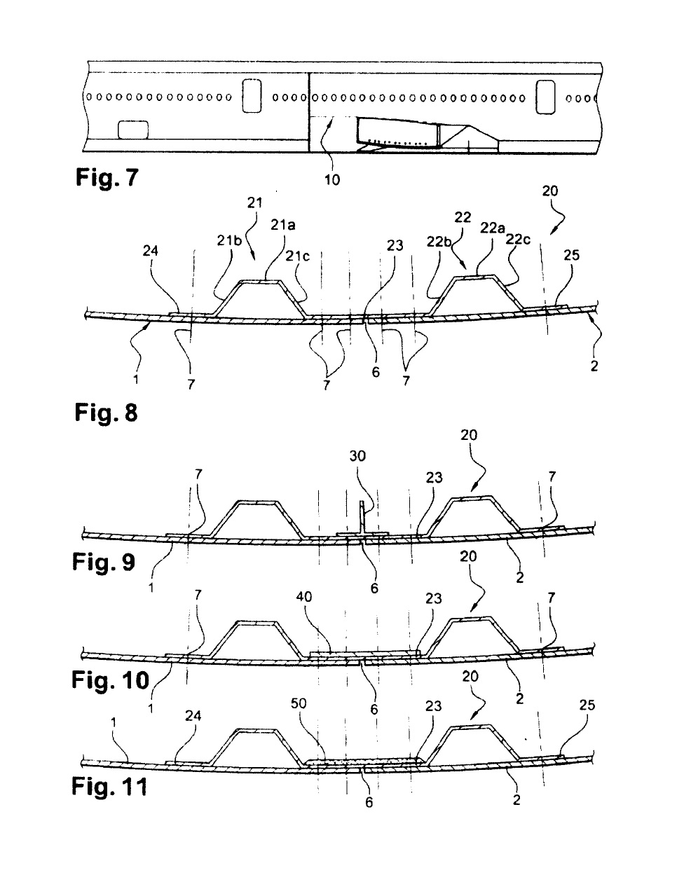

### DETAILED DESCRIPTION OF EMBODIMENTS OF THE INVENTION

The longitudinal joint of the invention comprises a double Ω stringer with central base-plate, able to be fastened onto a juncture between two fuselage panels. An example of such a longitudinal joint is shown on FIG. 8. This joint 20 with a double Ω stringer comprises a first Ω element, referenced 21, and a second Ω element, referenced 22, connected by a central base-plate 23. Each of these Ω elements comprises a head, respectively 21a and 22a, and two cores, respectively 21b, 21c and 22b, 22c. The head of each of these Ω elements, 21, 22, is able to secure elements of the structure.

Joint 20 also comprises a first base-plate 24 situated in the continuity of first core 21b of first Ω element, 21, as well as a second base-plate 25 situated in the continuity of second core 22c of second Ω element, 22.

The Ω elements and side base-plates 24 and 25 are identical to the Ω element and to the base-plate of a standard Ω stringer such as described above.

Joint 20 of the invention further comprises a central base-plate 23 connecting second core 21c of first Ω element 21 with first core 22b of second Ω element 22 and covering juncture 6 between the two panels 1 and 2. Central base-plate 23 has double the length of a standard Ω stringer base-plate.

Central base-plate 23 and side base-plates 24 and 25 are fastened onto panels 1 and 2 by standard fastening elements. More precisely, base-plate 24 is fastened onto panel 1 and base-plate 25 is fastened onto panel 2. Central base-plate 23 is fastened onto both panel 1 and panel 2.

From the preceding description, it is understood that the longitudinal joint of the invention has a total size corresponding to that of two Ω stringers placed end to end. It thus has the advantage of providing an even interval between the Ω stringers and the longitudinal joint. In fact, since longitudinal joint 20 has a length double that of an Ω stringer, the juxtaposition of Ω stringers and longitudinal joints 20 is even. The stringer system therefore may be uniform despite the presence of longitudinal joints.

With such a technique, the stringer system is relatively simple to implement because the joint with double Ω stringer may be placed at the juncture of the two panels while maintaining the earlier stringer system since the interval between two Ω stringers is maintained. In this way it is easy to change a panel cut-out on inserting a new longitudinal joint since it suffices to replace two standard Ω stringers by a juncture with double stringers.

Longitudinal joint 20 moreover makes it possible for additional elements to be inserted on central base-plate 23 so as to provide additional functions, according to requirements, at the said joint.

On FIG. 9, a cross-sectional view of a longitudinal joint according to the invention integrating a T stringer has been shown. In this example, a T stringer, referenced 30, has been mounted on central base-plate 23 of joint 20 in order to allow a possible securing of other elements. This T stringer may be fastened onto central base-plate 23 by the same fastening elements 7 as those fastening the central base-plate onto panels 1 and 2. It will be understood that, in this embodiment, the stringer system interval remains identical to that of an Ω stringer system, because T stringer 30 is simply installed above the longitudinal joint.

This embodiment of the longitudinal joint has been described for a T stringer. It is clearly understood that other types of stringers, for example U stringers, may be installed instead of the T stringer.

On FIG. 10, a cross-sectional view of a longitudinal joint of the invention integrating a clamp, also called strap, has been shown. In this example, an internal strap is positioned above central base-plate 23 and fastened, via central base-plate 23, to panels 1 and 2. A strap is a reinforcement element able to reinforce a structure. A strap may be internal, as on FIG. 10, that is to say installed on an inner face of the structure. It also may be external, that is to say installed on the outer face of the structure.

On FIG. 11, a cross-sectional view of a longitudinal joint of the invention integrating an over-thickness has been shown. In this example, an over-thickness is inserted in central base-plate 23. This over-thickness 50 may be made of composite material, by means of an additional fold making it possible to reinforce longitudinal joint 20 near juncture 6. The central base-plate then is made so as to be thicker, which allows it to provide additional functions or even to reinforce the joint between the panels in case of particularly substantial transfer of forces.

It will be seen that, in all the examples from FIGS. 8 to 10, fastening elements 7 of the longitudinal joint distributed on all the side and central base-plates have been shown. On the other hand, in the example from FIG. 11, only the fastening elements of central base-plate 23 and side base-plate 25 have been shown. In this example, first side base-plate 24 does not comprise any fastening element; it is co-bonded with panel 1.

In fact, joint 20 such as it has just been described is made of one and the same piece, following conventional production techniques for Ω stringers; only the shape of the production mold changes so as to obtain the double Ω shape. It therefore is possible to co-bond one of the side base-plates of the double omega stringer joint onto one of the panels, which makes it possible to eliminate a row of fastening elements and therefore reduce the overall weight of the aircraft. This embodiment furthermore leads to a saving of time during assembly of the panels.

The longitudinal joint that has just been described makes it possible to implement the end-to-end longitudinal assembly of all the panels of the fuselage, irrespective of the fuselage section considered. In fact, even markedly cone-shaped fuselage sections or one comprising orbital joints may be implemented, with the longitudinal joint of the invention, without requiring wedges.

1-9. (canceled)

10. An aircraft fuselage structure comprising:
at least a first and a second panel made of composite materials, placed side by side along a juncture and assembled with one another through at least one longitudinal joint,
wherein the longitudinal joint comprises a double Ω stringer comprising:
a first and a second Ω element each comprising a head and two cores,
a first side base-plate situated in continuity of a first core of the first Ω element,
a second side base-plate situated in continuity of a last core of the second Ω element, and
a central base-plate having a length double that of the first or of the second side base-plate and connecting the second core of the first Ω element with the first core of the second Ω element, the central base-plate covering the juncture between the two panels.

11. A structure according to claim 10, wherein the central base-plate is made in one piece with the Ω elements and the first and second side base-plates.

12. A structure according to claim 10, wherein the central base-plate is fastened onto each panel by fastening elements placed on both sides of the juncture.

13. A structure according to claim 10, wherein the longitudinal joint comprises a third stringer mounted on the central base-plate.

14. A structure according to claim 13, wherein the third stringer is a T stringer.

15. A structure according to claim 10, wherein the longitudinal joint comprises an internal or external clamp mounted on the central base-plate.

16. A structure according to claim 10, wherein the longitudinal joint comprises an over-thickness integrated into the central base-plate.

17. An aircraft fuselage comprising:
at least two sections assembled with a circumferential joint, wherein each section comprises a structure according to claim 10.

18. An aircraft, comprising at least one structure according to claim 10.
